(19) United States
(12) Patent Application Publication
(10) Pub. No.: US 2006/0005356 A1
(43) Pub. Date: Jan. 12, 2006

(54) Hinge device having angle hold function and folding electronic appliance using same

(75) Inventors: Masayuki Amano, Yokohama-Shi (JP); Ricky Barnett, Radlett (GB)

Correspondence Address: COHEN, PONTANI, LIEBERMAN & PAVANE, 551 FIFTH AVENUE, SUITE 1210, NEW YORK, NY, 10176, US

(73) Assignee: Nokia Corporation, Espoo (FI)

(21) Appl. No.: 11/167,987

(22) Filed: Jun. 27, 2005

Related U.S. Application Data
(63) Continuation of application No. PCT/JP03/16828, filed on Dec. 25, 2003.

(30) Foreign Application Priority Data
Dec. 25, 2002 (JP) 2002-374545

(51) Int. Cl. E05D 11/08

(52) U.S. Cl. 16/341

(57) ABSTRACT

This aims at providing a hinge device compact in size, and at securing a space sufficient for an FPC, etc. in manufacturing a cellular phone compact by use of the hinge device. The hinge device includes a shaft substantially long, a fixed cam provided allowing the shaft to rotate and having an angle holder, a movable cam provided to rotate about the shaft with rotation of the shaft and to slide along the shaft, and having an angle holder for holding at a predetermined angle an own rotation angle relative to the fixed cam cooperatively with the angle holder of the fixed cam, an elastic element always biasing the movable cam toward the fixed cam, a first arm fixed to the fixed cam, and a second arm fixed to the shaft. Here, the elastic element is to have a diameter provided as comparatively small correspondingly to the shaft substantially long.

### BACKGROUND OF THE INVENTION

1. Field of the Invention

The present invention relates to a hinge device, more particularly a hinge device having angle hold function, and a folding electronic appliance, particularly a folding cellular phone, using same.

2. Description of the Related Art

It is a practice to use a hinge devices having angle hold function in order to connect between the main body and the display of a folding electronic appliance, e.g. folding cellular phone. FIG. 8 shows, in fragmentary exploded perspective view, one example of a folding cellular phone 8 using a conventional hinge device having angle hold function. In this figure, the members are hinge devices 85 referred herein that is to be inserted into left-and-right horizontal holes in directions of arrows shown in the figure in order to connect between a main body 81 and a display 83 of a cellular phone. Those hinge devices 85 are pushed into the left-and-right horizontal holes 87 having rises 88. By fixing there the hinge devices 85 through utilization of their outer edges, the hinge devices 85 can be fixed in a state allowing to rotate the main body 81 and the display 83.

It should be noted that the conventional hinge device 85 has its length 82 comparatively short and its diameter 84 comparatively great. The length 82 provided comparatively short is because to secure a space for a flexible printed circuit board (FPC) 5 (see FIGS. 3 and 4, referred later) and coaxial cable (not shown) provided between the main body 81 and the display 83. Those FPC 5 and coaxial cable are necessarily provided striding between the man body 81 and the display 83 in order to enable signal transfer, etc. between the main body 81 and the display 83. However, in the conventional cellular phone 8, the space for passing those structurally exists only in a narrow gap laterally of the hinge device at between the main body 81 and the display 83. Particularly, the FPC has a considerably large width, e.g. 2 mm, as compared to the ordinary conductor line or the like. Accordingly, the conventional cellular phone is not necessarily secured with a space sufficient for the FPC.

Meanwhile, the diameter 84 provided comparatively great is due to the hinge device length 82 given comparatively short. As well known, in order to exhibit the angle hold function, an elastic member, e.g. a spring, is necessarily provided within the hinge device 85. As is apparent, in the case of using a spring having a different length to obtain the equivalent magnitude of elastic force, a spring shorter must have a diameter greater than that of a longer spring. The hinge device having a great diameter results in an increased size of the connection 89 between the main body 81 and the display 83 and hence of the cellular phone 8 itself. Thus, there is a difficulty in making the conventional hinge device compact in size.

Furthermore, where using the conventional hinge device 85, the hinge device 85 must be inserted laterally into the horizontal hole 87 of cellular phone 8 which requires the operation lateral thereof on the production line. Such a lateral operation is extremely troublesome as compared to a vertical operation, resulting in the increase in manufacturing and assembling costs.

Furthermore, the conventional structure requires such a troublesome operation as passing the FPC through a narrow gap laterally of the hinge device. In addition, there is a need to provide a rise 88 for fixing the hinge device in the horizontal hole 87 of the cellular phone 8. Those factors are also responsible for cost increase.

Furthermore, because the conventional electronic appliance, e.g. the cellular phone shown in FIG. 8, uses a hinge device similar in structure to all the electronic appliances, the design thereof also is similar hence raising the problem of difficulty in providing design difference.

Furthermore, the cellular phone 8 using the conventional hinge device has an angle the display 83 is opened relative to the main body 81 is limitedly up to the angle of communication, e.g. approximately 154 degrees. In the case such a cellular phone is accidentally trodden under foot, the cellular phone is to be possibly broken.

(Patent Document 1) JP-A-10-246222

### SUMMARY OF THE INVENTION

The present invention has been made in order to solve the problem in the prior art, and it is an object thereof to provide a hinge device more compact in size. Meanwhile, another object is to manufacture a cellular phone compact in size and innovative in design at low cost. Furthermore, it is still another object to provide a cellular phone highly secured.

In order to achieve the object, a hinge device of the invention comprises: a shaft substantially long; a fixed cam provided allowing the shaft to rotate and having an angle holder; a movable cam provided to rotate about the shaft with rotation of the shaft and to slide along the shaft, and having an angle holder for holding at a predetermined angle an own rotation angle relative to the fixed cam cooperatively with the angle holder of the fixed cam; elastic means always biasing the movable cam toward the fixed cam; a first arm fixed to the fixed cam; and a second arm fixed to the shaft.

In the hinge device, the elastic means may have a diameter provided comparatively small correspondingly to the shaft substantially long.

Meanwhile, a hinge device of the invention comprises: a shaft substantially long; a fixed cam supporting the shaft at a position close to one end of the shaft so as to allow rotation of the shaft and having a fixed surface having an angle holder on the other side of the shaft; a movable cam provided to rotate about the shaft with rotation of the shaft and to slide over the shaft along the shaft, and having an angle holder for holding at a predetermined angle an own rotation angle relative to the fixed cam by engagement with the angle holder of the fixed cam, in a rotation surface opposed to the fixed surface of the fixed cam; a spacer provided close to the other end of the shaft; a spring provided for expansion/contraction between the spacer and the movable cam and always biasing the movable cam toward the fixed cam; a first arm fixed to the fixed cam; and a second arm fixed to the shaft; wherein the spring means has a diameter provided as comparatively small correspondingly to the shaft substantially long.

Meanwhile, in the hinge device, the first arm and the second arm can define an angle varying in a range of at least substantially 0 degree to substantially 180 degrees. Meanwhile, a folding cellular phone may be formed by fixing a display and a main body to the first arm and the second arm of the hinge device. Furthermore, the hinge device may be provided on the cellular phone substantially over an entire width thereof.

### BRIEF DESCRIPTION OF THE DRAWINGS

FIG. 1 is an exterior perspective view of a folding cellular phone using a hinge device of the present invention, showing particularly a non-use state;

FIG. 2 is an exterior perspective view of a folding cellular phone using a hinge device of the present invention, showing particularly a use state;

FIG. 3 is a view showing a state that a main body and display is removed from FIG. 1

FIG. 4 is a view showing a state that a cover is removed from FIG. 3

FIG. 5 is an exterior perspective view of a hinge device of the invention, showing particularly a state that the angle defined by the hinge arms is held at approximately 0 degree;

FIG. 6 is a fragmentary magnifying perspective view of the hinge device of the invention, showing particularly a state that the angle defined by the hinge arms is held at approximately 154 degrees;

FIG. 7 is a fragmentary magnifying perspective view of the hinge device of the invention, particularly showing a state the angle defined by the hinge arms is extended up to approximately 180 degrees; and

FIG. 8 is a fragmentary exploded perspective view of a cellular phone using a hinge device of the prior art.

### DESCRIPTION OF THE PREFERRED EMBODIMENT

Although the hinge device of the present invention is applicable to various electronic appliances, explanation is herein made particularly on the application to a folding cellular phone as a preferred embodiment.

1. Outline

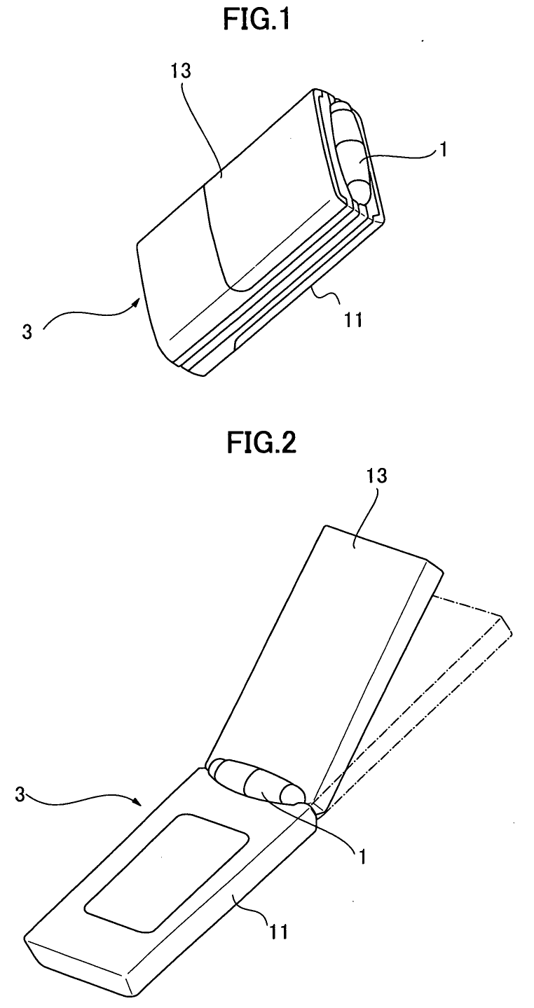

FIGS. 1 and 2 show exterior perspective views of a folding cellular phone of the present invention using a hinge device according to the invention. The folding cellular phone 3 has a main body 11 and a display 13 that are rotatably connected with each other by the utilization of a hinge device 1 of the invention. FIG. 1 shows particularly a non-use state while FIG. 2 particularly a use state, i.e. a state of communication or so.

As shown in the figures, the angle of between main body 11 and display 13 of the cellular phone 3 is approximately 0 degree during non-use in FIG. 1 while the angle of between main body 11 and display 13 is, say, approximately 154 degrees during the use in FIG. 2. As detailed in the below, the cellular phone 3 is to be rotated freely at least between 0 degree and 154 degrees and fixed to an angle of 154 degrees, similarly to the cellular phone using the conventional hinge device. However, the cellular phone 3 using a hinge device 1 of the invention is allowed to rotate up to 180 degrees exceeding 154 degrees, differently from the cellular phone using the conventional hinge device. However, as explained later, in the case of exceeding 154 degrees, spring back is effected to the angle 154 degree. By virtue of such a structure, the folding cellular phone 3 using the hinge device 1 of the invention can cope with an abnormal load. For example, even in the case the cellular phone 3 is trodden under foot from above, the cellular phone is not to be broken unless the main body 11 and the display 13 are opened to an angle of approximately 180 degrees or greater. Nevertheless, such hold angle and rotatable angle can be freely established by the designer without limited to the angle exemplified above, as clear from the following explanations.

2. Hinge Device and Its Peripheral Members

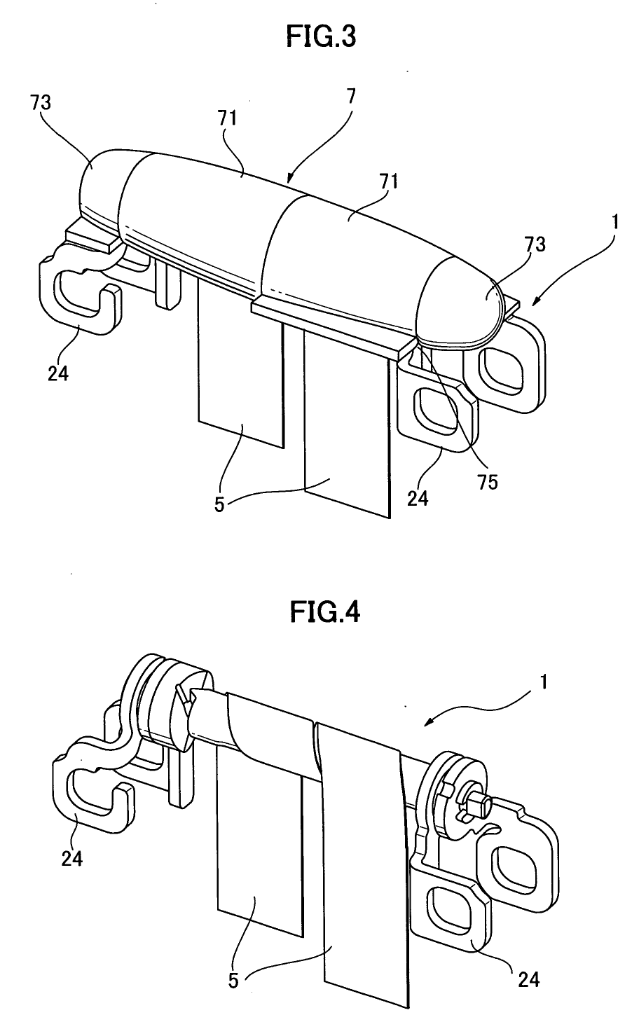

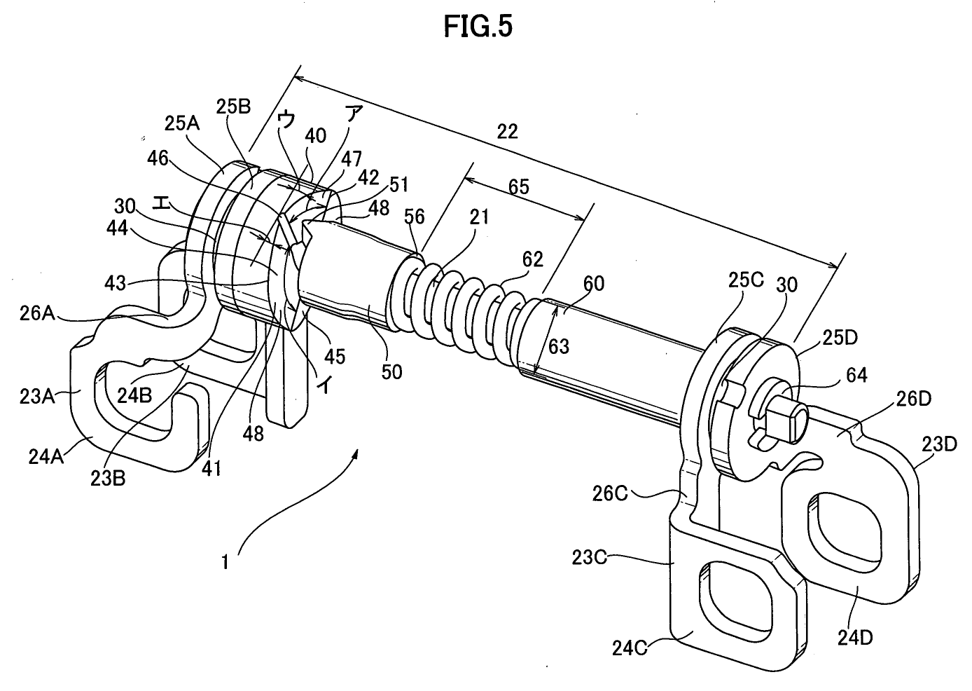

There are shown exterior perspective view in FIG. 3 a state the main body and display is removed from FIG. 1, in FIG. 4 a state the cover for hinge device is removed from FIG. 3, and further in FIG. 5 a state the FPC is removed from FIG. 4, respectively. Of these figures, FIG. 5 just shows the hinge device 1 of the invention.

As favorably shown in FIG. 4, there is provided an FPC 5 having ends to be connected respectively to the main body 11 and the display 13 (see FIGS. 1 and 2), in nearly the center of the hinge device 1 of the invention. The FPC 5 has a comparatively large width of 8 mm for example, and arranged in a state wound twice over there. Winding the FPC 5 is because to improve the resistance to repetitive bending on the FPC. However, the width and number of turns of FPC is, of course, not limited to those exemplified here. In the case of using the hinge device 1 of the invention, the FPC 5 can be provided in a state wound over the hinge device 1. In other words, it can be provided over the full width of the hinge device 1. Accordingly, when connecting between the main body and the display, there is no need of such a troublesome operation as passing the FPC through a narrow gap laterally of the hinge device as required in the conventional.

As favorably shown in FIG. 3, a cover 7 covering the hinge device 1 has, say, four portions, i.e. two cylindrical portions 71 having horizontal slits and two lid-like portions 73 arranged at both ends thereof. Particularly, the cylindrical cover portion 71 is cut with a horizontal slit 75 for externally drawing the FPC 5, lengthwise between both ends (incidentally, although the horizontal slit 75 is shown only on the right, a similar slit may be considered provided also on the left). These cover portions 71, 73 cover nearly the entire of the hinge device 1 except for the region of hinge-arm fixing points 24 and their surroundings where the main body 11 and the display 13 (see FIGS. 1 and 2) of the cellular hone are directly connected together.

Referring to FIG. 5, explanation is now made on the structure of the hinge device of the invention. The hinge device 1 of the invention includes a shaft 21 comparatively long (at least longer than that of a hinge device 85 used in the conventional cellular phone 8), hinge arms 23A, 23B arranged close to one end of the shaft, hinge arms 23C, 23D arranged close to the other end of the shaft, annular washers 30 provided respectively between the hinge arms 23A and 23B and between the hinge arms 23C and 23D, an annular cam (fixed cam) 40 provided on the side close to the hinge arms 23A, 23B, a cylindrical cam follower (movable cam) 50 for movement responsive to an action of the cam, a cylindrical spacer 60 arranged close to the other end of the shaft, a spring 62 provided between the spacer 60 and the cam follower 50 and always biasing the cam follower 50 toward the cam 40, and a C-form stopper (E-ring) 64 for preventing the hinge arm 23, etc. from falling out of the shaft 21.

Although not clear from the figure, the hinge arms 23A, 23C of these members are fixed to the shaft 21 directly or indirectly. Accordingly, by rotating the hinge arm 23A, 23C, the shaft 21 is rotated. The cam follower 50 is provided to rotate about the shaft and to slide over the shaft 21 and along the shaft 21 as the shaft 21 rotates. Meanwhile, the hinge arms 23B, 23D are fixed mutually to the cam 40 directly or indirectly but not fixed to the shaft 21. Accordingly, the hinge arms 23B, 23D and the cam 40 do not rotate even when the shaft 21 rotates. It is not problematic here whether or not the other members, i.e. the spring 62, the spacer 60 and the stopper 64 are to rotate due to a rotation of the shaft 21. It can be basically considered that no rotation takes place even when the shaft 21 rotates, similarly to the hinge arms 23B, 23D, etc.

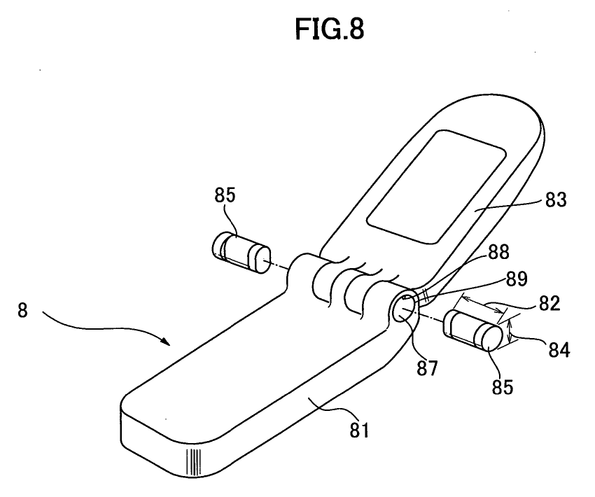

The shaft 21, penetrating centrally of the hinge device 1, is provided over nearly the entire width thereof. The shaft 21 has a length 22 capable of determining a width of the hinge device 1 and, ultimately, a width of a cellular phone 3 using the hinge device 1 of the invention. More specifically, the hinge device 1 of the invention can be provided between the display 13 and the main body 11, i.e. over the entire width of the cellular phone, to make the width of cellular phone 3 nearly equal to the width of the hinge device 1. This is because, where the hinge device 1 of the invention is used, as explained referring to FIGS. 3, and 4, there is no need of providing a gap lateral of the hinge device in order to attach an FPC 5, the spring 62 (and the spacer 60) can be set freely in length. Also, the hinge device 85 (see FIG. 8) is not required two in the number as needed on the conventional cellular phone. As clear from the below explanation, the length 22 of the shaft 21 used in the invention, more specifically the width of the cellular phone 3 of the invention using the hinge device 1 of the invention, is greater than the length 82 of one conventional hinge device 85, shown in FIG. 8. However, it can be easily set smaller than the width (length thereof) of the cellular phone 3 using the conventional hinge device 1 (or can be set greater, of course).

The hinge arms 23A-23D are to be fixed to the subject of hinge connection, e.g. the display 11 and main body 13 (see FIGS. 1 and 2) of cellular phone 3. The hinge arms 23A-23D have fixing portions 24A-24D to be fixed to the main body and display, and annular portions 25A-25D to be inserted over the shaft 21. The fixing portions 24A-24D and the annular portions 25A-25D are connected together in a state twisted 90 degrees through bend portions 26A-26D (26B being not shown) The fixing portion 24A, 24C of the hinge arm 23A, 23C is fixed to the display 13 (see FIGS. 1 and 2) of the cellular phone 3 by inserting a screw (not shown) in the center thereof. Meanwhile, the fixing portion 24B, 24D of the hinge arm 23B, 23D is fixed to the main body 11 (see FIGS. 1 and 2) of the same by the similar way. Meanwhile, the annular portion 25A, 25C of the hinge arm 23A, 23C is fixed to one end of the shaft 21 in a state the shaft 21 penetrates through a hole thereof (not shown). The annular portion 25C, 25D of the hinge arm 23C, 23D is provided in a state the shaft 21 is inserted through a hole thereof (not shown) and in a state the shaft 21 within the hole is allowed to rotate freely. Incidentally, the fixing portion 24A-24D is determined in its form by taking into consideration merely screwing to the cellular phone 3, which form is to be determined depending upon the subject of hinge connection thus being limited to the form shown.

The cam 40 is arranged close to one end of the shaft 21, in a state the shaft 21 penetrates through a hole (not shown) provided in the center thereof and in a state the shaft 21 is allowed to freely rotate at the inside of the hole. The cam 40 allows the shaft 21 to rotate at the inside thereof during rotation of the shaft 21 but does not move itself due to rotation of the shaft. The cam 40 has two slant surface, i.e. a first slant surface 44 and a second slant surface 45, such that the cam 40 decreases its thickness from the center the shaft 21 penetrates toward the circular edge 43, bordering a predetermined diameter partitioning into halves the fixed surface 41 on the other end of the shaft 21, in other words, the diameter 42 assumes a crest. Incidentally, although the second slant surface 45 is not favorably represented in the figure, the slant surfaces 44, 45 are provided with a groove 46 in a predetermined depth extending from the center to the edge 43 of the cam 40. The groove 46 is to be used to hold the angle of cam follower by engagement with the protrusions 51, 53 of the cam follower, as described later. The slant surfaces 44, 45 have two fan-formed slant surfaces, i.e. a first fan surface 47 and a second fan surface 48, respectively formed at slant angles somewhat different bordering the groove 46. Here, the first fan surface 47 has an internal angle A of approximately 56 degrees while the second fan surface 48 has an internal angle B of approximately 124 degrees. Because the first fan surface 47 and the second fan surface 48 are both slanted to have the deepest valley at the groove 46, there are somewhat difference between the slant angle C of the first fan surface 47 (i.e. cam 40 thick-wise slant) and the slant angle Dof the second fan surface 48 in relation to the internal angles A, B. Namely, the slant angle C of the first fan surface 47 is provided greater than the slant angle D of the first fan surface 48.

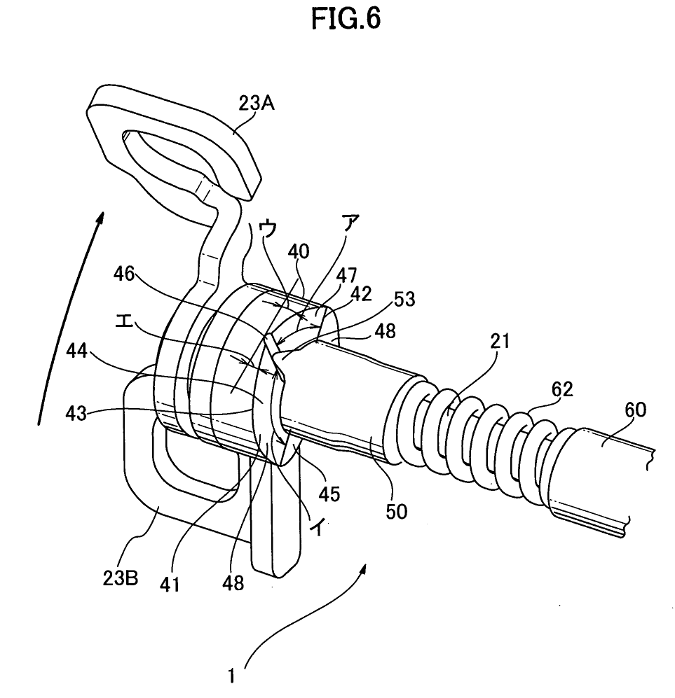

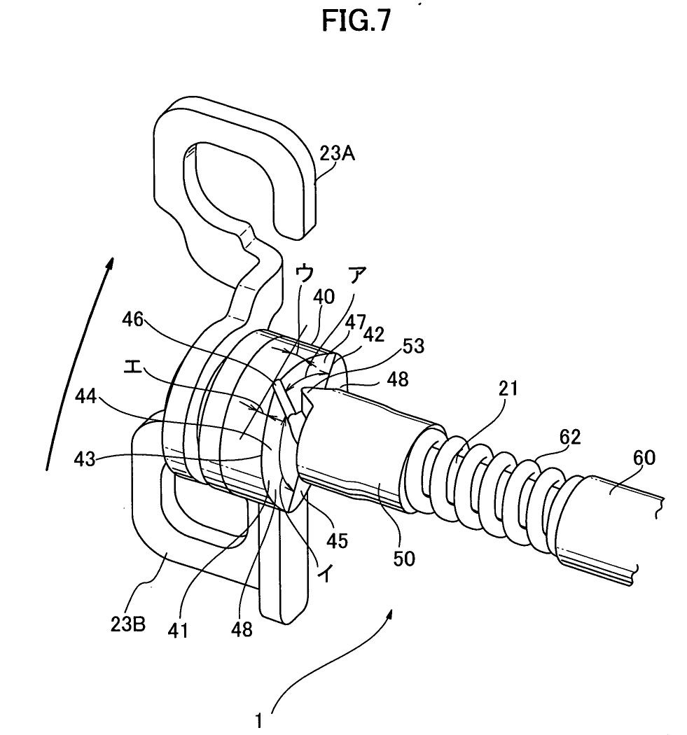

The cam follower 50 is provided, in a state the shaft 21 penetrates through a hole (not shown) provided in its center, to rotate about the shaft 21 as the shaft 21 rotates and further to slide over the shaft 21 along the shaft 21. The cam follower 50 has protrusions two in total, i.e. a first protrusion 51 and a second protrusion 53 in the rotation surface opposed to the fixed surface 41 of cam 40, correspondingly to the groove 46 of cam 40 (see FIGS. 6 and 7). The first protrusion 51 and the second protrusion 53 are provided symmetric as viewed at the center of the cam follower 50. By an engagement of the first and second protrusions 51, 53 in the groove 46 of cam 40, the rotation angle of the cam follower 50 relative to the fixed cam (the resulting angle of between hinge arms 23A, 23C and hinge arms 23B, 23D that are respectively fixed to those) can be held at a predetermined, e.g. 154 degree. Incidentally, the cam follower 50 has the other end 56 always in a contact state with the spring 62, described in the following.

The spring 62 is provided for expansion/contraction between the cam follower 50 and the spacer 60, in a state the shaft 21 penetrate through the interior thereof and in a state the shaft 21 is allowed to rotate at the inside thereof. The spring 62 always biases the cam follower 50 toward the cam 40. Particularly, when the protrusion of cam follower 50 fits in the groove 46 of cam 40, the same plays an important role in order to hold that state. The spring 62 must have a sufficient elastic force to effect this role. In order to provide a sufficient elasticity, a sufficient length 65 must be provided in relation to the size of the diameter 63. As noted above, according to the hinge device 1 of the invention, because the length 65 of the spring 62 can be freely set, the spring 62 can be easily made longer in its length 65 than that of the spring 62 of the conventional hinge device 1. By thus setting the spring 62 length 65 longer than that of spring (82) of the conventional hinge device 8, the diameter 63 of spring 62 (and further the hinge device 1 diameter using the spring 62) can be made smaller than that (84) of the conventional. As a result, the invention can make more compact the hinge device 1 and the cellular phone 3 using the same.

The spacer 60 is arranged between the spring 62 and the hinge arms 23C, 23D in a state the shaft 21 penetrate through the interior thereof and preferably in a state the shaft 21 is allowed to freely rotate at the inside thereof. Properly adjusting the length of the spacer 60 makes it possible to adjust the biasing force of the spring 62 to the cam 40. Incidentally, in order for the spacer 60 not to apply an unnecessary force to the hinge arm 23C, a pin (not shown) may be provided in a manner partitioning between the spring 62 and the hinge arm 23C. The pin, for example, radially extends from the shaft 21 orthogonally to the shaft 21, having a length nearly equal to or smaller than the radius of the spacer 60. Incidentally, as clear from the above explanation, the length of the spacer 60 is determined relatively in relation to the biasing force, etc. of the spring 62.

Stoppers 64 are provided outermost at both ends of the shaft 21 thus preventing hinge arms 23, etc. from falling out of the shaft 21. The stoppers 64 are arranged adjacent the annular portions 25A, 25D of the hinge arms 23A, 23D, to fix the shaft 21 firmly at the C-formed inside thereof in a manner clamping same there. Incidentally, although the stoppers 64 may be provided as separate members from other members as in the illustrated example, those may be formed by rolling the ends of the shaft 21.

3. Hinge Device Operation

Referring subsequently to FIG. 5 and further to FIGS. 6 and 7, the operation of the hinge device is explained.

When viewed in respect of operation, FIG. 5 shows a state the hinge arms 23A, 23C and the hinge arms 23B, 23D define an angle held at approximately 0 degree, which can be considered showing a non-use state shown in FIG. 1 if considering the cellular phone 3 example shown in FIGS. 1 and 2. Meanwhile, FIG. 6 shows a state the angle of between those is held at approximately 154 degrees, which can be considered showing a use state (state of communication or so) shown in FIG. 2 if considering the cellular phone 3 example. FIG. 7 shows a state the angle of between those is extended to approximately 180 degrees, which can be considered showing a state of abnormality if considering the cellular phone 3 example. Note that, in FIGS. 6 and 7, the cam 40 and its periphery only is shown as a fragmentary magnifying perspective view.

As shown in FIG. 5, when the hinge arms 23A, 23C and 23B, 23D define an angle of approximately 0 degree, those hinge arms are allowed to move only in the direction the angle thereof increases, in other words, only in the direction the first protrusion 51 (and second protrusion 53) goes up the slanting, first fan-formed surface 47. Accordingly, this state is maintained unless a certain force is applied to the hinge arms 23A, 23C.

In the FIG. 5 state, when to rotate the hinge arms 23A, 23C in the direction of arrow shown in the figure or to open the display if considered on the cellular phone 3 example, the cam follower 50 fixed on the hinge arms 23A, 23C is rotated together with the hinge arms 23A, 23C while being pushed toward the spacer 60 against the force of spring 62. At this time, the first protrusion 51 (and second protrusion 53) is to move the first fan-formed surface 47 in a direction of going up the slant surface thereof. Accordingly, in case the force to move the hinge arms 23A, 23C is loosened in the course thereof, the cam follower 50 rotates reverse in direction to the arrow shown in the figure thus possibly making a spring-back to the former position.

When the hinge arms 23A, 23C are rotated nearly 30 degrees in the direction of arrow shown in the figure without loosening the force for rotation, the first protrusion 51 (and second protrusion 53) of cam follower 50 gets over the crest of the diameter 42 of cam 40 and then moves the second fan-formed surface 48 in a direction going down the slant surface thereof. Accordingly, unless a force is applied reverse in direction to the arrow shown in the figure, the can follower 50 does not return to the former position again. The action getting over the crest corresponds to opening/closing operation of the display and main body if considered on the cellular phone example.

As favorably shown in FIG. 6, when the angle of rotation reaches approximately 154 degrees, the second protrusion 53 (first protrusion 51) reaches the groove 46 of the first slant surface 44 (second slant surface 45). As a result, the cam follower 50 snaps into fitting in the groove 46 of cam 40 by the action of spring 62. Because the cam follower 50 is always biased toward the cam 40 by means of the spring 62, this state or the angle of 154 degrees is maintained unless any of force is applied to the hinge arms 23A, 23C.

In abnormality, when the hinge arms 23A, 23C are rotated exceeding 154 degrees in the arrow direction shown in the figure relative to the hinge arms 23B, 23D, or when the display is opened exceeding the state of communication relative to the main body if considered on the example of cellular phone 3, as shown in FIG. 7 the cam follower 50 is rotated together with the hinge arms 23A, 23C exceeding 154 degrees while being pushed toward the spacer 60 against the force of spring 62. At this time, the second protrusion 53 (first protrusion 51) of cam follower 50 goes out of the groove 46 of cam 40 and moves up the first fan-formed surface 47. Accordingly, the cam follower 50 undergoes a force in the direction opposite to the direction of arrow shown in the figure. As a result, the hinge arms A, C are allowed to make a spring-back to the former angle, or 154 degrees.

4. Assembling

Referring to FIGS. 1 to 5, brief explanation is finally made on a method of assembling the hinge device 1 of the invention into a cellular phone 3. Before assembling to the cellular phone 3, the hinge device 1 is made in the state of FIG. 3. This is to be done by winding an FPC 5 over the shaft of hinge device 1 as shown in FIG. 4 (not assembled with hinge arms 23C, 23D and a stopper, in this stage), attaching cylindrical covers 71 to the FPC 5 wound shaft from both sides in a manner wrapping those together with the FPC from the external, assembling hinge arms 23C, 23D and fixing the respective ends by a stopper 64, and finally attaching lid cover portions 73 on the both sides of the cylindrical cover portions 71. As a result, a hinge device is obtained in the state of FIG. 3. Then, the fixing portions 24A-24D of hinge arms 23A-23D exposed from the cover 7 are screwed, from above, with the main body 11 and display 13 of the cellular phone 3. Furthermore, the ends of FPC 5 exposed from the cover are respectively connected to predetermined positions of the main body 11 and display 13. Finally, the lids, etc. of main body 11 and display 13 are closed into a completion.

In this manner, in the cellular phone 3 using the hinge device 1 of the invention, there is no need of complicated operations including passing an FPC through a narrow gap laterally of a hinge device and assembling a hinge device 85 laterally as required in a cellular phone 8 (see FIG. 8) using a conventional hinge device 85. Furthermore, there is also no need of providing a cellular phone 8 with a hole 87 (see FIG. 8) horizontally and a rise 88 there as needed in the case using a conventional hinge device. Accordingly, in the case of using the hinge device of the invention, it is possible to fabricate a cellular phone cheaper in price than those of the conventional. Meanwhile, because the hinge device of the invention is apparently different in shape from the conventional hinge device, it is possible to easily produce a design different from that of the conventional cellular phone or electronic appliance by use of the hinge device of the invention.

Incidentally, the embodiment fixed the cam to provide the cam follower rotatable, the cam follower may be fixed to provide the cam rotatable conversely. Meanwhile, although the embodiment provided the hinge-arm extension angle at approximately 180 degrees, it can be provided greater than that. This angle can be determined freely in relation to the subject of hinge device connection (and its structure), etc.

The invention allows for fabricating a compact hinge device at low cost. Meanwhile, The invention can provide an innovatively designed electronic appliance and a highly secure cellular phone.

1. A hinge device comprising:
a shaft substantially long;
a fixed cam provided allowing the shaft to rotate and having an angle holder;
a movable cam provided to rotate about the shaft with rotation of the shaft and to slide along the shaft, and having an angle holder for holding at a predetermined angle an own rotation angle relative to the fixed cam cooperatively with the angle holder of the fixed cam;
elastic means always biasing the movable cam toward the fixed cam;
a first arm fixed to the fixed cam; and
a second arm fixed to the shaft.

2. A hinge device according to claim 1, wherein the elastic means has a diameter provided comparatively small correspondingly to the shaft substantially long.

3. A hinge device comprising:
a shaft substantially long;
a fixed cam supporting the shaft at a position close to one end of the shaft so as to allow rotation of the shaft and having a fixed surface having an angle holder on the other side of the shaft;
a movable cam provided to rotate about the shaft with rotation of the shaft and to slide over the shaft along the shaft, and having an angle holder for holding at a predetermined angle an own rotation angle relative to the fixed cam by engagement with the angle holder of the fixed cam, in a rotation surface opposed to the fixed surface of the fixed cam;
a spacer provided close to the other end of the shaft;
a spring provided for expansion/contraction between the spacer and the movable cam and always biasing the movable cam toward the fixed cam;
a first arm fixed to the fixed cam; and
a second arm fixed to the shaft;
wherein the spring means has a diameter provided as a comparatively small diameter correspondingly to the shaft substantially long.

4. A hinge device according to claim 1, wherein the first arm and the second arm define an angle varying in a range of at least substantially 0 degree to substantially 180 degrees.

5. A folding cellular phone formed by fixing a display and a main body to the first arm and the second arm of the hinge device according to claim 1.

6. A folding cellular phone according to claim 5, wherein the hinge device is provided on the cellular phone substantially over an entire width thereof.

7. A folding electronic appliance having a hinge device according to claim 3.

8. A folding electronic appliance having a hinge device according to claim 1.
